(19) United States
(12) Patent Application Publication
(10) Pub. No.: US 2023/0413353 A1
(43) Pub. Date: Dec. 21, 2023

(54) INTER-PLMN USER PLANE INTEGRATION

(71) Applicant: Comcast Cable Communications, LLC, Philadelphia, PA (US)

(72) Inventors: Ana Lucia Pinheiro, Allen, TX (US); Robert Jaksa, Irving, TX (US); Samian Kaur, Plymouth Meeting, PA (US); Stephie Lim, The Colony, TX (US)

(21) Appl. No.: 18/333,646

(22) Filed: Jun. 13, 2023

Related U.S. Application Data
(60) Provisional application No. 63/351,675, filed on Jun. 13, 2022.

(51) Int. Cl. H04W 76/10; H04W 8/02; H04L 61/2503; H04W 64/00; H04W 12/06

(52) U.S. Cl. CPC H04W 76/10; H04W 8/02; H04W 92/02; H04W 64/00; H04W 12/06; H04L 61/2503

(57) ABSTRACT

Methods, apparatuses, and systems are described for improving data accessibility between home network operators and roaming network operators. An intermediate session management function of a first operator and a session management function of a second operator may be connected via an interface. A session may be created between a user device and a data network based on the intermediate session management function and the session management function.

### CROSS-REFERENCE TO RELATED APPLICATIONS

This application claims the benefit of U.S. Provisional Application No. 63/351,675, filed Jun. 13, 2022, which is incorporated herein in its entirety.

### BACKGROUND

Network operators provide access to networks and the Internet. Network users may require access outside of an area of subscription, available base station access areas, or other coverage limitations. Roaming may be provided through other network operators, which can increase the cost of subscriber data services or voice services. These costs may be allocated to the home network operator based on aggregated data through the Internet service provider of the roaming network operator.

### SUMMARY

It is to be understood that both the following general description and the following detailed description are exemplary and explanatory only and are not restrictive. Methods, apparatuses, and systems are described for improving data accessibility between home network operators and roaming network operators.

Roaming may be provided by a visiting network operator. Interfaces may be used to provide interconnection between functions of the network. For example, an intermediate session management function (e.g., I-SMF) may be used to expand the service coverage of network. For example, the intermediate session management function may be part of a network for an operator (e.g., the roaming network). The intermediate session management function may be connected with a session management function of another network for another operator (e.g., the home network) via an interface (e.g., N16a). A session may be created between a user device and a data network (e.g., the Internet) according to both the intermediate session management function and the session management function. One more policies may be used to control traffic of the session.

This summary is not intended to identify critical or essential features of the disclosure, but merely to summarize certain features and variations thereof. Other details and features will be described in the sections that follow.

### BRIEF DESCRIPTION OF THE DRAWINGS

In order to provide understanding techniques described, the figures provide non-limiting examples in accordance with one or more implementations of the present disclosure, in which:

FIG. 1 shows an example system in accordance with one or more implementations of the present disclosure;

FIG. 2 shows an example communication architecture in accordance with one or more implementations of the present disclosure;

FIG. 3 shows a flowchart of an example method in accordance with one or more implementations of the present disclosure;

FIG. 4 shows a flowchart of an example method in accordance with one or more implementations of the present disclosure; and

FIG. 5 shows a flowchart of an example method in accordance with one or more implementations of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

As will be appreciated by one skilled in the art, hardware, software, or a combination of software and hardware may be implemented. Furthermore, the methods and systems may take the form of a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a special purpose computer or other programmable data processing instrument to produce a machine, such that the processor-executable instructions which execute on the computer or other programmable data processing instrument create a device for implementing the steps specified in the flowchart block or blocks.

These processor-executable instructions may also be stored in a non-transitory computer-readable memory or a computer-readable medium that may direct a computer or other programmable data processing instrument to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing instrument to cause a series of operational steps to be performed on the computer or other programmable instrument to produce a computer-implemented process such that the processor-executable instructions that execute on the computer or other programmable instrument provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

The techniques disclosed herein may be implemented on a computing device in a way that improves the efficiency of its operation. As an example, the methods, instructions, and steps disclosed herein improve the functioning of a computing device.

Roaming may be provided by a visiting network operator. Interfaces may be used to provide interconnection between functions of the network. For example, an intermediate session management function (e.g., I-SMF) may be used to expand the service coverage of network. For example, the intermediate session management function may be part of a network for an operator (e.g., the roaming network). The intermediate session management function may be connected with a session management function of another network for another operator (e.g., the home network). An instance of the intermediate session management function may be executed by hardware on the visiting network or the home network. An interface, (e.g., N16a) may be used to ensure proper communication between the intermediate session management function and the session management function. For example, forwarding action rules and packet detection rules may be defined in a policy and used by the user plane function to steer traffic to the non-roaming data network. The interface may be encapsulated by a security edge protection proxy (e.g., SEPP). In such a way, a session may be created between a user device and a data network (e.g., the Internet) according to both the intermediate session management function and the session management function and the intermediate session management function and the session management function may be operated by different network operators.

Policies may be used to control traffic of the session. For example, quality of service (QoS) or other initiatives may be required by the policy. Policies may be exchanged between the intermediate session management function and the session management function, other unified data management functions, or another repository. Such exchanges may also be encapsulated by the security edge protection proxy. For example, a policy from the home network operator may be stored on the policy control function of the roaming network operator along with other policies from the roaming network operator. One or more of the policies may be transferred to the session management function on the roaming network and on to the user plane functions (e.g., the uplink classifier, anchor). The policy, or policies, may include filters or steering rules, and policies may contain lists of rules. Policies may be sent as a datagram, and policies may be based on a round trip time. The round trip time may be defined between user plane functions of different networks. The policy may be based on a subscriber profile or data network name (DNN), and the policy may include Internet Protocol (IP) information (e.g., destination address and destination port). The policy may be based on the user device. For example, data may be forwarded based on the user device or a class of user devices.

With these and other technical improvements discussed herein, a network operator may avoid having data and voice traffic from user devices traverse an Internet service provider from a roaming network operator. This data reduction may reduce traffic and other burdens on roaming network operators and allow home network operators to take on the burden of serving data and Internet traffic to the data network or Internet.

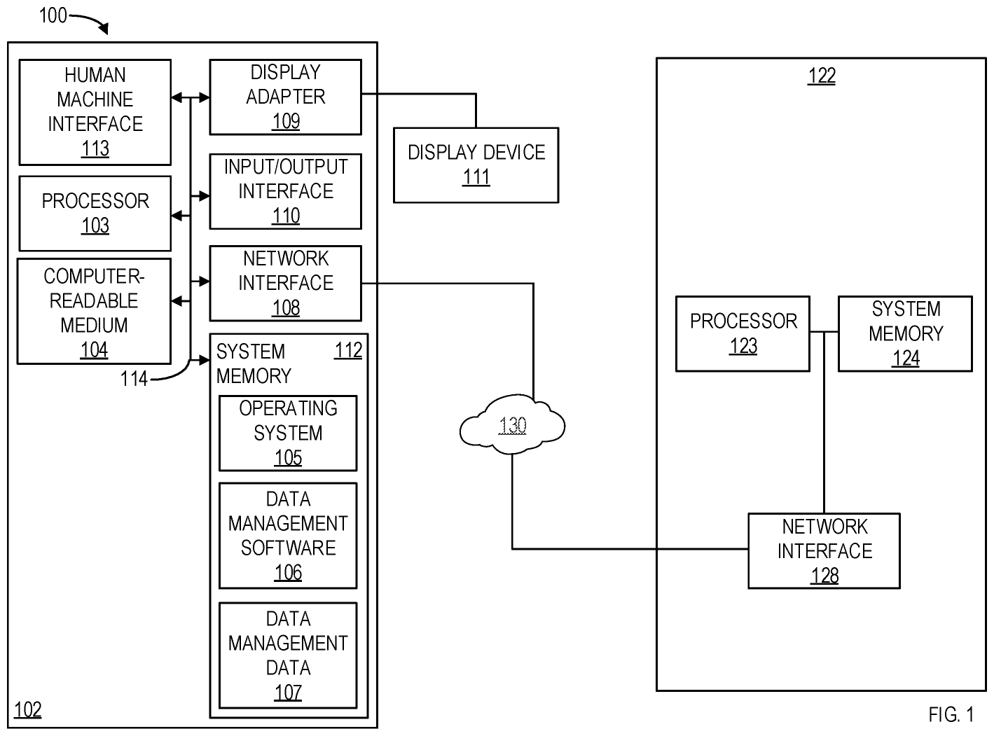

FIG. 1 shows an example system 100 in accordance with one or more applications of the present disclosure. The system 100 may comprise a device 102, a display device 111, and one or more computing devices 122. The device 102 may comprise one or more processors 103, a system memory 112, and a bus 114 that couples various components of the device 102 including the one or more processors 103 to the system memory 112. In the case of multiple processors 103, the device 102 may utilize parallel computing.

The bus 114 may comprise one or more of several possible types of bus structures, such as a memory bus, memory controller, a peripheral bus, an accelerated graphics port, and a processor or local bus using any of a variety of bus architectures.

The device 102 may operate on and/or comprise a variety of user device readable media (e.g., non-transitory). User device readable media may be any available media that is accessible by the device 102 and comprises, non-transitory, volatile and/or non-volatile media, removable and non-removable media. The system memory 112 has user device readable media in the form of volatile memory, such as random access memory (RAM), and/or non-volatile memory, such as read only memory (ROM). The system memory 112 may store data such as data management data 107 and/or programs such as operating system 105 and data management software 106 that are accessible to and/or are operated on by the one or more processors 103.

The device 102 may also comprise other removable/non-removable, volatile/non-volatile user device storage media. The computer-readable medium 104 may provide non-volatile storage of user device code, user device readable instructions, data structures, programs, and other data for the device 102. The computer-readable medium 104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of programs may be stored on the computer-readable medium 104. An operating system 105 and data management software 106 may be stored on the computer-readable medium 104. One or more of the operating system 105 and data management software 106 (e.g., mobile applications), or some combination thereof, may comprise program and the data management software 106. Data management data 107 may also be stored on the computer-readable medium 104. Data management data 107 may be stored in any of one or more databases known in the art. The databases may be centralized or distributed across multiple locations within the network 130.

A user may enter commands and information into the device 102 via an input device. Such input devices may comprise, but are not limited to, a keyboard, a pointing device (e.g., a computer mouse, a remote control), a microphone, a joystick, a scanner, tactile input devices such as gloves, and other body coverings, motion sensors, and the like. These and other input devices may be connected to the one or more processors 103 via a human machine interface 113 that may be coupled to the bus 114, but may be connected by other interface and bus structures, such as a parallel port, game port, an IEEE 1394 Port (also known as a Firewire port), a serial port, network interface 108, and/or a universal serial bus (USB).

A display device 111 may also be connected to the bus 114 via an interface, such as a display adapter 109. It is contemplated that the device 102 may have more than one display adapter 109 and the device 102 may have more than one display device 111. A display device 111 may be a monitor, an LCD (Liquid Crystal Display), light emitting diode (LED) display, television, smart lens, smart glass, and/or a projector. In addition to the display device 111, other output peripheral devices may comprise components such as speakers and a printer which may be connected to the device 102 via Input/Output Interface 110. Any step and/or result of the methods may be output (or caused to be output) in any form to an output device. Such output may be any form of visual representation, including, but not limited to, textual, graphical, animation, audio, tactile, and the like. The display device 111 and the device 102 may be part of one device, or separate devices.

The device 102 may operate in a networked environment using logical connections to one or more computing devices 122. A computing device 122 may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, an edge device or other common network node, and the like. Logical connections between the device 102 and the computing device 122 may be made via a network 130. Such network connections may be through a network interface 108. A network interface 108 may be implemented in both wired and wireless environments.

Application programs and other executable program components such as the operating system 105 are shown herein as discrete blocks, although it is recognized that such programs and components may reside at various times in different storage components of the device 102, and are executed by the one or more processors 103 of the device 102. The computing device 122 may include all of the components described with regard to the device 102.

The device 102 may comprise one or more components configured to communicate over electromagnetic waves or other mediums. The device 102 may be configured with one or more subscriber identity modules (SIM). The SIM may be stored in persistent memory, embedded, physical, or combinations thereof. In such a way, the SIM may form a credential circuit as data stored permanently or otherwise on the device 102.

The device 102 may be configured to communicate over a network interface 108. The network interface 108 may be configure with a radio or other electromagnetic spectrum transceiver. The network interface 108 may be combined with a SIM, and identification numbers (e.g., international mobile subscriber identity, local area identity) and keys therein (e.g., kᵢ), for secure communications. The SIM may be issued by the home network provider and may allow for access on the visiting network.

The device 102 may communicate with the computing device 122 over a network 130. Such communication paths may include wired communication technologies, wireless communication technologies, or combinations thereof. Wireless communication technologies may include various 3GPP standards (e.g., LTE, 5G) and Institute of Electrical and Electronics Engineers (IEEE) standards (e.g., 802.11). Wired communication technologies may include various IEEE standards (e.g., 802.3). While various communication technologies and standards are contemplated herein, various communication mediums (e.g., wire, air), standards making organizations (e.g., 3GPP, IETF, IEEE), and protocols are contemplated herein.

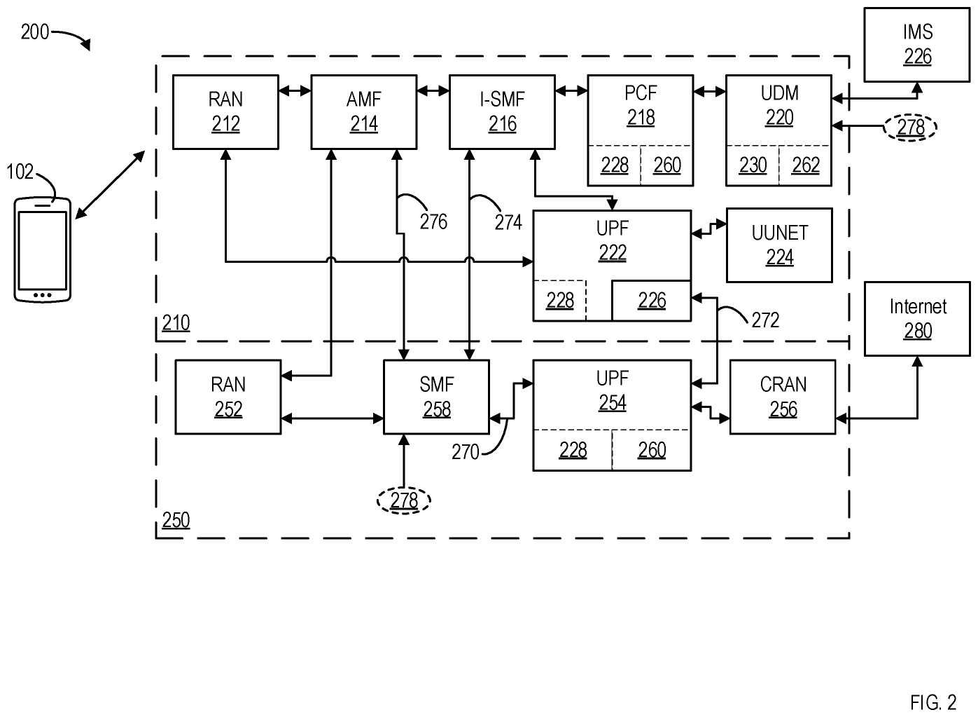

FIG. 2 shows an example architecture 200 in accordance with one or more implementations of the present disclosure. The architecture 200 may include a network 210 (e.g., a network of a first operator). The network 210 may include wireless communication protocols between the device 102 and a radio access network 212. The radio access network 212 may include one or more base station (e.g., eNB, gNB), which may be based on various radio access technologies. The radio access network 212 may be considered an edge device because it is the outward facing node from the network 210 to the device 102. The network may include communications hardware and software to support various protocols and components (e.g., 3GPP 5G, IEEE 802.11). An operator may be defined as a Public Land Mobile Network (PLMN) (e.g., Visiting PLMN, Home PLMN), mobile network operator (MNO), multiple system operator (MSO), or another operator indicator, which are intended for designation (e.g., first, second, third) to distinguish between different networks and are not intended to be rigid as terminology and the scope of these and other terms is evolving in the field.

An operator of one or more networks (e.g., network 210, network 250) may issue subscriptions for the device 102 to access one or more of the networks (e.g., network 210, network 250). The subscriptions may be issued in packages (e.g., subscription packages) and stored or unpacked on an embedded SIM or otherwise. The subscription may be identified or designated by a credential on the SIM.

A network (e.g., network 210, network 250) may be defined as a set of components, instances, functions, servers, interfaces, other implements and combinations thereof that are configured to communicate or have access to communicate with one another. The network (e.g., network 210, network 250) may consist of those components, instances, functions, servers, interfaces, other implements and combinations that are managed by a network provider and configured to communicate. A network (e.g., network 210, network 250) may be designated through a logical grouping of the set (e.g., subnet). A network (e.g., network 210, network 250) may be virtually grouped logically (e.g., virtual private network) or contain portions that are virtually grouped logically.

A network (e.g., network 210, network 250) may be implemented on one or more computing devices 122. For example, a computing device 122 may be formed on one or more containers or instances having instructions configured to form one or more of the functions described herein. For example, an access and mobility function (AMF), session management function (SMF), policy control function (PCF), other functions or instances, or combinations thereof may perform some or all of the steps described herein with one or more computing devices 122.

The access and mobility management function 214 may be the entry function of the control plane and may connect to the core network. The access and mobility management function 214 may terminate the non-access stratum (NAS) of the device 102. The access and mobility management function 214 may also perform access authentication for the device 102 and mobility management. Additionally, the access and mobility management function 214 may route session management messages to the one or more intermediate session management functions 216.

The intermediate session management function 216 may be responsible for termination of a session based on the session management function from the device 102. The intermediate session management function 216 may allocate Internet Protocol addresses and provide control of the user plane function 222 (UPF) of network 210 and user plane function 254 of network 250. User plane function 222 may include a packet filter. The packet filter may be based on internet protocol (IP) addresses and port numbers of the destination or origin. The packet filter may be specific to the device 102. The packet filter may be configured by the policy control function 218.

The intermediate session management function 216 may be configured to terminate sessions associated with the policy control function 218 (PCF) of network 210. The intermediate session management function 216 may be configured to communicate with the access and mobility management function 214 over the N11 interface and the policy control function 218 over the N7 interface. The intermediate session management function 216 may provide the user plane function 222 with packet handling instructions, routing information, packet detection rules, forwarding action rules, other policy information, or combinations thereof, which may be received from or provided to the other session management function 258 of network 250.

The policy control function 218 may enable policy rules described herein and enable control functions for enforcement. These rules may be distributed and enforced at the device 102 or other functions described herein. As an example, the policy control function 218 may enable route and slice selection.

The user plane function 222 may implement the packet forwarding and routing for user plane data in the role of the inter-radio access technology (RAT). The user plane function 222 may also provide IP address allocation when instructed by the intermediate session management function 216 and may provide gating or downlink data buffering. The user plane function 222 may be configured to communicate with the intermediate session management function 216 over the N4 interface. The N4 interface may include hops on one or more data networks or the Internet. The user plane function 222 may communicate with a data network (e.g., UUNET 224 or another Internet service provider 224) over an N6 interface to the Internet 280.

The user plane function 222 may be configured to provide uplink classification, wherein the uplink classification may enable relation of the matching traffic filters provided by the intermediate session management function 216. For example, the intermediate session management function 216 may be configured to provide global access to the user plane function 222 of network 210 by diverting traffic to the user plane function 254 of network 250. The configuration may happen during or after the PDU session is established. In such a way, packets may be properly forwarded from user plane function 222 of network 210 to user plane function 254 of network 250 and on to the N6 reference of the data network (e.g., CRAN 256 or another Internet service provider) and on to the Internet 280. Proper address allocation may be provided by network 210 or network 250 to ensure that traffic from the device 102 is properly forwarded through both user plane functions 222, 254 to the CRAN 256.

The intermediate session management function 216 may apply filtering rules at user plane function 222 to ensure the data from the device 102 is properly forwarded to the user plane function 254 over an N4 interface (e.g., interface 270) that is inter-PLMN. For example, the interface between the intermediate session management function 216 and the user plane function 254 is established across networks of more than one operator (e.g., inter-PLMN).

Network functions of both networks 210, 250 may be configured to facilitate the inter-PLMN. For example, unified data management 220 of network 210 may provide user authentication for user devices (e.g., device 102) with subscriber information for both network 210 and network 250. For example, credentials 230, 262 may be stored in the function for unified data management 220. A user device (e.g., device 102) may attempt to access network 210 based on a subscriber identity or credentials provided by the network 250 (e.g., credentials 262). The credentials 262 may be used to authenticate the user device (e.g., device 102) for access to the network 210. Network 250 may routinely update the credentials 262 based on the function for unified data management 220 or a unified data repository. The network 210 can authenticate the user device (e.g., device 102) and engage the intermediate session management function 216 to established packet forwarding (e.g., uplink classification) on the user plane function 222 to ensure data is forwarded to the user plane function 254 over an interface (e.g., interface 272). In an example, interface 272 may comprise an N9 interface.

The intermediate session management function 216 may further receive a policy from the policy control function 218. For example, the policy control function 218 may include one or more policies 228, 260 for each network 210, 250. In an example, a policy may comprise a fair usage policy. For example, the fair usage policy may limit the speed (e.g., bitrate, bandwidth) of access for the device 102 based on one or more policies. For example, the policy 228 may control data based on the device 102 on network 210. The policy 260 may control data based on the device 102 on network 250. The policy control function 218 may send both policies 228, 260 to the intermediate session management function 216. The intermediate session management function 216 may forward the policies 228, 260 to the user plane function 254. The intermediate session management function 216 may also forward the policy 228 to the user plane function 222. The network 250 may further include a radio access network 252. The radio access network 252 may be configured to allow non-roaming or home based service based on network 250 and user plane function 254.

The session management function 258 may be configured to communicate with the user plane function 254 over an interface (e.g., an N4 interface). The session management function 258 may communicate with the access and mobility management function 214 over interface 276 (e.g., an N11 interface) and unified data management over interface 278, which may also include communications with the policy control function 218. The session management function 258 may communicate with the intermediate session management function 216 over an N16a interface. For example, address translation may be performed by a translation of an address associated with communications of the N16a interface from a subnet of network 210 to a subnet of the network 250 or to a subnet of network 210 from a subnet of the network 250. The N16a interface may traverse a security edge protection proxy. For example, the intermediate session management function 216 and the session management function 258 may communicate over a tunnel or encapsulation. The tunnel or encapsulation may be encrypted and secured by pre-shared keys or exchanged through a handshake.

The session management function 258 may receive policy or user access information based on or from the unified data management 220. For example, the session management function 258 may receive policies 228, 260. The session management function 258 may implement policies 228, 260 on the user plane function 254. For example, the user plane function 254 may include a filter similar to filter 226. The user plane function 254 may be configured by the session management function 258 over interface 270.

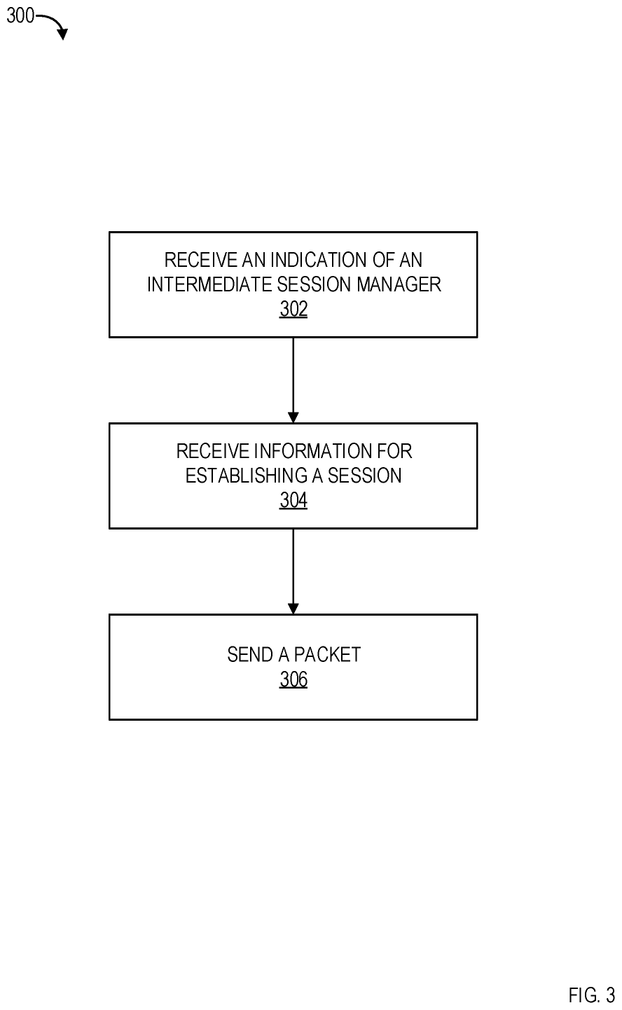

FIG. 3 shows a flowchart of an example method 300 in accordance with one or more implementations of the present disclosure. Method 300 may be implemented by any of the devices, nodes, instances, or functions discussed herein and combinations thereof. For example, method 300 may be implemented by the device 102, one or more computing devices 122, other nodes, instance, functions, or combinations thereof. Individual functions are provided as an example and for clarity. Other functions or combinations thereof are contemplated by this disclosure.

In step 302, an indication may be received. The indication may be provided by one or more instances or functions associated with the networks 210, 250. The indication may be generated based on a location of a user device (e.g., device 102) after a request for access to one or more of the networks 210, 250. The location may be outside of a service area associated with the session management function 258. For example, the session management function 258 may be associated with radio access network 252 and the location may be outside or beyond the service area associated with radio access network 252. The indication may be based on communications between the session management function 258 and the access and mobility management function 214. For example, the access and mobility management function 214 may query the session management function 258 for support of the user device (e.g., device 102) based on the location. The session management function 258 may respond that support is not provided, and network 210 may initialize the intermediate session management function 216 for supporting the device 102 in the service area of radio access network 212.

In step 304, the information for establishing a session may be received. For example, the session may enable data access between the user device (e.g., device 102) and the data network or data network name (e.g., CRAN 256). For example, the information may be based on an interface (e.g., interface 274). The interface may comprise an N16a interface. The information may be further based on communications between the session management function 258 and the intermediate session management function 216. For example, the session management function 258 and the intermediate session management function 216 may exchange rules and policies associated with respective user plane functions 222, 254.

As an example, the session may be further based on the credentials 230, 262. For example, the credentials 230, 262 may be stored on the user device (e.g., device 102) and sent to the network 210. The credentials may be compared with stored credentials on network 210, 250. For example, a copy of the credentials or a key for validation of the credentials may be stored in unified data management 220.

As an example, the session management function 258, the intermediate session management function 216, one or more other functions, or a combination thereof may establish a session. The session may traverse user plane functions 222, 254, wherein one or more of the user plane functions may be configured for uplink classification and may act as an anchor. For example, the session management function 258, the intermediate session management function 216, one or more other functions, or a combination thereof may send a configuration or information for uplink classification and user plane function anchoring to the intermediate session management function 216 or a combination of the intermediate session management function 216 and the session management function 258.

The intermediate session management function 216 may determine which user plane functions (e.g., user plane functions 222, 254) to use from networks 210, 250 associated with the user device (e.g., device 102) and the credentials 230, 262. For example, the determination of user plane functions for use may be based on credentials 230, 262 or subscription information provided from the user device (e.g., device 102). For example, the user plane function may be determined based on a level of service indicated by the subscription information or other credentials. As an example, the user plane functions may be selected based on policies 228, 260. For example, the user plane function may be determined based on the data consumption by the user device (e.g., device 102) over a billing period. The available bandwidth or bitrate may be throttled based on consumption of data by the user device (e.g., device 102) or other factors. As an example, location data of the user device (e.g., device 102), the base station, radio access network 212, or other networking hardware may be used to determine user data plane functions with the shortest round trip time (RTT). For example, a user plane function of network 250 may be selected with the lowest round trip. Round trip times may be stored in a repository (e.g., unified data repository) or determined upon connection. The user plane function may be determined based on other network parameters (e.g., packet loss ratio).

The intermediate session management function 216, the session management function 258, or combination thereof may send configuration information to one or more of the user plane functions 222, 254. For example, the intermediate session management function 216, the session management function 258, the user plane functions 222, 254, or combination thereof may send Quality of Service (QoS) flow identification information (e.g., QFI) or Reflective QoS indication (e.g., RQI). In step 310, the interface 272 (e.g., an N9 interface) may be formed to communicate across networks 210, 250 between user plane function 222 and user plane function 254. The N4 interface functionality may be extended to create the N9 tunnel or a new interface may be added between the user plane functions 222, 254. The packet filter 226 may be used to filter data sent to the user plane function 254 from other data received by the user plane function 222. For example, the packet filter may filter data based on an IP address and port numbers of the origin or destination.

In step 306, a packet may be sent. For example, the packet may be received and sent by one or more components of network 210. For example, the packet may be forwarded from user plane function 222 to user plane function 254. The packet may be sent based on an established session or information related to the session. The information may include session based information (e.g., sequence numbers) to enable communications between the user device (e.g., device 102) and the data network (e.g., CRAN 256). For example, the packet may traverse radio area network 212, user plane function 222, and user plane function 254, and the data network (e.g., CRAN 256) in order to provide Internet access to the user device (e.g., device 102) over the data network of network 250.

Address translation may be provided by the N16a interface because the session management function 258 and the intermediate session management function 216 may be on different subnets. For example, the intermediate session management function 216 may be on a subnet for network 210 and the session management function 258 may be on a subnet for network 250. The intermediate session management function 216 may be initialized based on the location of the user device (e.g., device 102). For example, network 210 may initialize the intermediate session management function 216 when the user device (e.g., device 102) is not within radio access network 252. The intermediate session management function 216 may be deconstructed, stopped, paused or otherwise removed from network 210 when the location of the user device (e.g., device 102) is within range of radio access network 252. A policy may be sent to the user device (e.g., device 102) to ensure that the user device (e.g., device 102) also complies with policies of network 210.

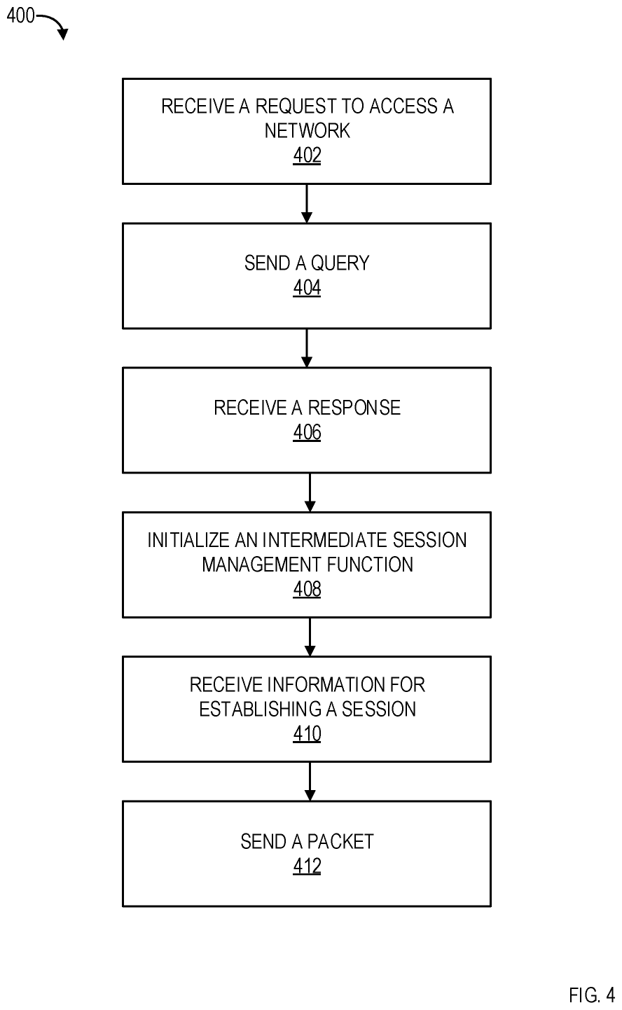

FIG. 4 shows a flowchart of an example method 400 in accordance with one or more implementations of the present disclosure. The method 400 may be performed by any of the devices, nodes, instances, or functions discussed herein and combinations thereof. For example, the method 400 may be performed by the user device 102, one or more computing devices 122, other nodes, instance, functions, or combinations thereof. Individual functions are provided as an example and for clarity. Other functions or combinations thereof are contemplated by this disclosure.

In step 402, a request to access a network may be received. For example, a user device (e.g., device 102) may send a request to access network 210 or network 250. In step 404, a query may be sent. The query may be configured to request whether a location of the user device (e.g., device 102) is within a service area associated with network 250. The query may be sent to a session management function (e.g., session management function 258).

In step 406, a response may be received. For example, the response may be received from the session management function. The response may comprise an indication of whether the user device (e.g., device 102) is within the service area of radio access network (e.g., radio access network 252) or the session management function (e.g., session management function 258). In an example, the response may be received by network 210 or the access and mobility management function 214.

In step 408, an intermediate session management function may be initialized. For example, the response may prompt initialization of an intermediate session management function (e.g., intermediate session management function 216). The intermediate session management function 216 may be configured to provide session management for the user device (e.g., device 102) with access to network 210. The intermediate session management function 216 may be loaded from a repository associated with network 210 and an instance may be initialized or the intermediate session management function 216 may be added to an already initialized or running instance.

In step 410, information for establishing a session may be received. For example, the intermediate session management function 216 may receive the information for establishing a session. The information may enable uplink classification on the user plane and communications to traverse the networks 210, 250 to the data network of network 250. In an example, the information may be received based on an N16a interface with the session management function 258.

In step 412, a packet may be sent. For example, the packet may be received by network 210 from the user device (e.g., device 102), wherein network 210 may send the packet to network 250. In an example, additional data may be sent (e.g., transmitted) with the session between the user device (e.g., device 102) and the data network (e.g., CRAN 256).

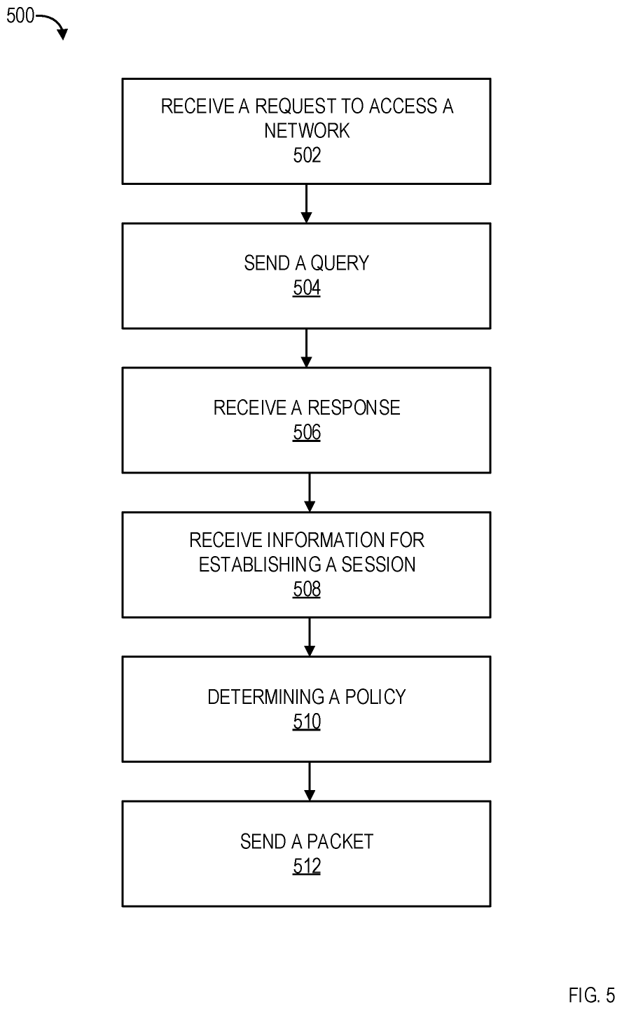

FIG. 5 shows an example method 500 in accordance with one or more implementations of the present disclosure. The method 500 may be performed by any of the devices, nodes, instances, or functions discussed herein and combinations thereof. For example, the method 500 may be performed by the user device 102, one or more computing devices 122, other nodes, instance, functions, or combinations thereof. Individual functions are provided as an example and for clarity. Other functions or combinations thereof are contemplated by this disclosure.

In step 502, a request to access a network may be received. For example, the user device (e.g., device 102) may send a request to access network 210 or network 250. In step 504, a query may be sent. The query may be configured to request whether a location of the user device (e.g., device 102) is within a service area associated with network 250. The query may be sent to a session management function (e.g., session management function 258).

In step 506, a response may be received. For example, the response may be received from the session management function. The response may comprise an indication of whether the user device (e.g., device 102) is within the service area of radio access network (e.g., radio access network 252) or the session management function (e.g., session management function 258). In an example, the response may be received by network 210 or the access and mobility management function 214. An intermediate session management function 216 may be configured to provide session management for the user device (e.g., device 102) with access to network 210. The intermediate session management function 216 may be loaded form a repository associated with network 210 and an instance may be initialized or the intermediate session management function 216 may be added to an already initialized or running instance.

In step 508, information for establishing a session may be received. For example, the intermediate session management function 216 may receive the information for establishing a session. The information may be configured to enable uplink classification on the user plane and communications to traverse the networks 210, 250 to the data network of network 250. In an example, the information may be received based on an N16a interface with the session management function 258.

In step 510, a policy may be determined. For example, the policy may be determined based on the information for establishing the session. In an example, the policy may be implemented on one or more of the user plane functions 222, 254 control data traffic traversing interface 272 or networks 210, 250.

In step 512, a packet may be sent. For example, the packet may be received by network 210 from the user device (e.g., device 102), wherein network 210 may send the packet to network 250. In an example, additional data may be transmitted with the session between the user device (e.g., device 102) and the data network (e.g., CRAN 256). The packet may be transmitted in accordance with the policy and all data transmitted over the session may be transmitted in accordance with the policy (e.g., bandwidth throttling).

The network functions described herein may be generally referred to as a generic combination function that may run on one or more servers, one or more instances, one or more sets of instructions, and so on. Such instances may be containerized, replicated, scaled, and distributed by network 210, 250 to meet the growing demands of respective networks. Any of the steps or functions described in one or more of the methods, architectures, or call flows described herein may be used in conjunction with any of the other methods, architectures, or call flows described herein. Any of the components (e.g., network functions, user equipment, servers) may perform any of the steps from any of the methods or call flows described herein even though not specifically described and may be performed in combination with any of the other components. Network functions described herein are defined by respective code or compilations of machine instructions for execution on one or more processors, instances, or servers. It should be appreciated that the techniques described herein relate to various protocols and technology and may at least apply to 3G, LTE, and 5G technologies.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, based on a location of a user device, an indication of an intermediate session management function of a network of a first operator, wherein the location is beyond a service area associated with a session management function of a network of a second operator;
receiving, based on an N16a interface associated with the intermediate session management function of the first operator and the session management function of the network of the second operator and based on credentials of a subscriber to the network of the second operator indicative of the user device having access to the network of the second operator, information for establishing a session associated with the user device and a data network name of the second operator; and
sending, based on the information, a packet.

2. The method of claim 1, further comprising translating an address associated with communications of the N16a interface from a subnet of the network of the first operator to a subnet of the network of the second operator.

3. The method of claim 1, further comprising receiving the credentials of the subscriber.

4. The method of claim 1, further comprising:
verifying the credentials of the subscriber; and
sending a policy based on the credentials to the intermediate session management function.

5. The method of claim 1, further comprising:
based on the indication, initializing an instance of the intermediate session management function of the first operator.

6. The method of claim 5, further comprising:
determining, based on a second location of the user device, that the second location is within the service area of the session management function of the second operator; and
stopping the instance of the intermediate session management function of the first operator.

7. The method of claim 1, further comprising:
sending a policy to the user device, wherein the packet traverses the network of the second operator according to the policy.

8. The method of claim 7, wherein the policy is indicative of a quality of service associated with the session.

9. A method comprising:
receiving a request to access a network of a first operator;
sending, based on the request, a query to a session management function of a second operator;
receiving, based on a location of a user device and the query, a response from the session management function of the second operator;
initializing, based on the response, an intermediate session management function of the first operator;
receiving, based on an N16a interface associated with the intermediate session management function of the first operator and the session management function of the network of the second operator, information for establishing a session associated with the user device and a data network name of the second operator; and
sending, based on the information, a packet.

10. The method of claim 9, further comprising translating an address associated with communications of the N16a interface from a subnet of the network of the first operator to a subnet of the network of the second operator.

11. The method of claim 9, further comprising receiving credentials of a subscriber associated with the user device.

12. The method of claim 1, further comprising:
verifying the credentials of the subscriber; and
sending a policy based on the credentials to the intermediate session management function.

13. The method of claim 9, further comprising:
determining, based on a second location of the user device, that the second location is within a service area of the session management function of the second operator; and
stopping an instance of the intermediate session management function of the first operator.

14. The method of claim 9, further comprising:
sending a policy to the user device, wherein the packet traverses the network of the second operator according to the policy.

15. The method of claim 14, wherein the policy is indicative of a quality of service associated with the session.

16. The method of claim 9, wherein a user plane function of the network of the first operator or a user plane function of the network of the second operator classifies an uplink associated with the session.

17. The method of claim 9, wherein the information is further based on credentials of a subscriber to the network of the second operator indicative of the user device having access to the network of the second operator.

18. A method comprising:
receiving a request to access a network of a first operator;
sending, based on the request, a query to a session management function of a network of a second operator;
receiving, based on a location of a user device and the query, a response from the session management function of the network of the second operator;
receiving, based on an N16a interface associated with an intermediate session management function of the network of the first operator and the session management function of the network of the second operator, information for establishing a session associated with the user device and a data network name of the second operator;
determining, based on the information, a policy associated with a user plane function; and
sending, based on the information and the policy, a packet.

19. The method of claim 18, wherein the packet traverses the network of the second operator according to the policy.

20. The method of claim 19, wherein the policy is indicative of a quality of service associated with the session.
